(19) United States
(12) Patent Application Publication
(10) Pub. No.: US 2021/0232627 A1
(43) Pub. Date: Jul. 29, 2021

(54) GAME LIBRARY VISUALIZATION AND RECOMMENDATION USING ONTOLOGICAL MAPPING ON INFORMATION HANDLING SYSTEM

(71) Applicant: Dell Products L.P., Round Rock, TX (US)

(72) Inventors: Richard W. Schuckle, Austin, TX (US); Marc Randall Hammons, Round Rock, TX (US); Erik Summa, Austin, TX (US); Nikhil M. Vichare, Austin, TX (US); Tek Prasad Basel, Austin, TX (US); Katherine Anne Craig, Austin, TX (US)

(73) Assignee: Dell Products L.P., Round Rock, TX (US)

(21) Appl. No.: 16/774,527

(22) Filed: Jan. 28, 2020

(51) Int. Cl. G06F 16/904; G06F 16/903; G06F 16/9035; G06F 16/9038; G06F 16/908

(52) U.S. Cl. CPC G06F 16/904; G06F 16/90348; G06F 16/908; G06F 16/9038; G06F 16/9035

(57) ABSTRACT

Computer programs for execution on an information handling system may be illustrated using an ontological mapping that uses data regarding the computer programs to arrange the computer programs into a navigable display that improves the ability of a user to find organize and find their programs and allows the information handling system to make useful recommendations to the user regarding additional computer programs of interest. The ontologically-mapped programs may be visualized on a display that is customizable based on a user's interests. For example, programs may be mapped and visualized as a universe by grouping related programs into solar systems. Data regarding the programs may be used to generate details within the solar system, such as appearance of the planets in the solar systems, location of the planets in the solar systems, and moons orbiting the planets in the solar systems. A user's ontologically-mapped programs may be compared to other user's ontologically-mapped programs or to an available set of programs to identify related programs that may be of interest to the user.

### FIELD OF THE DISCLOSURE

The instant disclosure relates to information handling systems. More specifically, portions of this disclosure relate to managing applications on an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may be configured to perform generic processing, and configured by an end user through computer software programs stored in memory of the information handling system to perform specific processing. For example, some users may execute video game applications on the information handling system. Whether games or other applications, the number of applications resident on an information handling system can become large and difficult to navigate. An example library system for computer software programs is shown in FIG. 1. A library 100 includes icons 102 corresponding to various computer programs available for execution on the information handling system. However, such a library is difficult to navigate, particularly for large quantities of programs.

Shortcomings mentioned here are only representative and are included to highlight problems that the inventors have identified with respect to existing information handling systems and sought to improve upon. Aspects of the information handling systems described below may address some or all of the shortcomings as well as others known in the art. Aspects of the improved information handling systems described below may present other benefits than, and be used in other applications than, those described above.

### SUMMARY

Computer programs may be illustrated using an ontological mapping that uses data regarding the computer programs to arrange the computer programs into a navigable display that improves the ability of a user to organize and find their programs and allows the information handling system to make useful recommendations to the user regarding additional computer programs of interest. The ontologically-mapped programs may be visualized on a display that is customizable based on a user's interests. For example, programs may be mapped and visualized as a universe by grouping related programs into solar systems. Data regarding the programs may be used to generate details within the solar system, such as appearance of the planets in the solar systems, location of the planets in the solar systems, and moons orbiting the planets in the solar systems. A user's ontologically-mapped programs may be compared to other user's ontologically-mapped programs or to an available set of programs to identify related programs that may be of interest to the user. For example, if one user's solar system includes programs A, B, and C, and another user's solar system includes programs A, B, and D, then the users may be recommended programs D and C, respectively, as programs of potential interest.

According to one embodiment, a method may include retrieving, by an information handling system, telemetry data for a plurality of applications; mapping, by the information handling system, the plurality of applications to an ontological map based, at least in part, on the telemetry data; and generating, by the information handling system, a visualization of at least a portion of the plurality of applications based on at least a portion of the ontological map. Embodiments of the invention, including this method and variations thereof, can be implemented on an information handling system or in a non-transitory computer readable medium comprising code for performing the described operations and methods.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a screen shot illustrating a conventional library of computer programs.

FIG. 2 is a block diagram illustrating a system for generating an ontological-based visualization of computer programs according to some embodiments of the disclosure.

FIG. 3 is a flow chart illustrating a method of generating an ontological-based visualization of computer programs according to some embodiments of the disclosure.

FIG. 4A is a graphical depiction illustrating a solar-system visualization of computer programs according to some embodiments of the disclosure.

FIG. 4B is a screen shot illustrating an example mapping of computer programs into a solar-system visualization according to some embodiments of the disclosure.

FIG. 4C is a screen shot illustrating an example mapping of computer programs into a world visualization according to some embodiments of the disclosure.

FIG. 5A is a graphical depiction illustrating a planet visualization for related computer games according to some embodiments of the disclosure.

FIG. 5B is a screen shot illustrating an example mapping of computer programs into a planet visualization according to some embodiments of the disclosure.

FIG. 5C is a graphical depiction of details for a planet visualization according to some embodiments of the disclosure.

FIG. 5D is a graphical depiction of additional details for a planet visualization according to some embodiments of the disclosure.

FIG. 5E is a graphical depiction of further details for a planet visualization according to some embodiments of the disclosure.

FIG. 5F is a graphical depiction of additional details for a planet visualization according to some embodiments of the disclosure.

FIG. 6 is a screen shot illustrating an example planet visualization for a recommended computer game according to some embodiments of the disclosure.

FIG. 7 is a block diagram illustrating a method for recommending games or profiles according to some embodiments of the disclosure.

FIG. 8 is a block diagram illustrating a recommendation system according to some embodiments of the disclosure.

FIG. 9 is a screen shot illustrating a virtual reality visualization for a solar-system visualization according to some embodiments of the disclosure.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

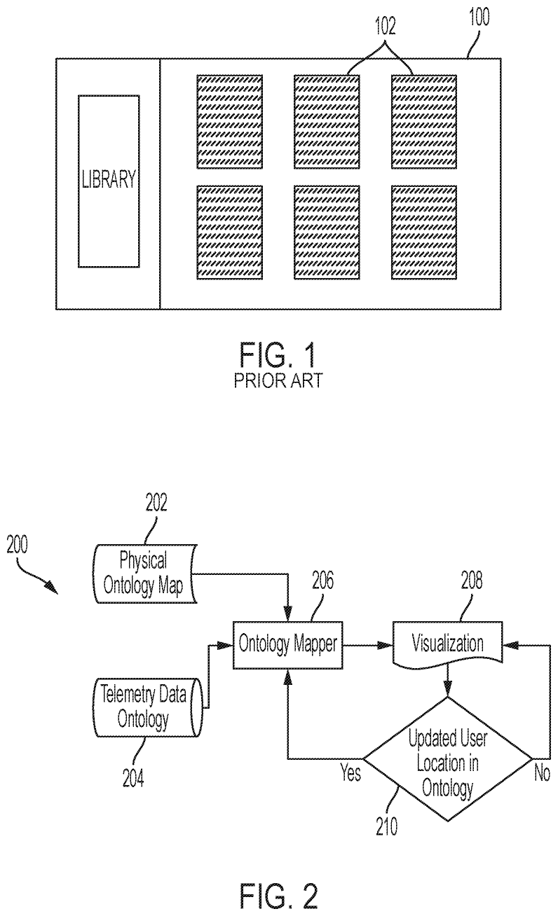

The information handling system may execute code retrieved from a computer program product to process data regarding a set of computer programs to generate an ontological mapping and a visualization of the computer programs based on the ontological mapping. In some embodiments, the mapping and visualization are performed on a single information handling system. In some embodiments, the aspects of the mapping and visualization functions may be performed on different information handling systems. FIG. 2 is a block diagram illustrating a system for generating an ontological-based visualization of computer programs according to some embodiments of the disclosure. A system 200 includes telemetry data ontology dataset 204 that includes data regarding the set of computer programs. Telemetry data may include game-related data (e.g., game name, type, genre, summary), user-related data (e.g., types of games played, how often, system settings when gaming), and/or device-related data (e.g., system type, games installed, system hardware/software configuration). The system 200 also includes physical ontology map 202 that includes a definition of an ontology map into which compute programs may be mapped based on telemetry data 202 for the computer programs. An ontology mapper 206 retrieves the map 202 and the data 204 and performs the mapping of computer programs into the defined ontology of the map 202 using the data 204. The mapping of computer programs may be provided to a visualization engine 208, which generates a graphical display, such as for a graphical user interface (GUI) to be displayed on a computer monitor or TV. The visualization engine 208 may, for example, generate a view of a universe with related computer programs grouped into solar systems, and individual planets in the solar systems corresponding to individual programs. A user may navigate through the universe to identify programs of interest. The user's decision to change location at block 210 may cause the ontology mapper 206 to be activated for the new location and feed data to the visualization engine 208 to generate a new display with a new set of programs related to the user's location in the universe.

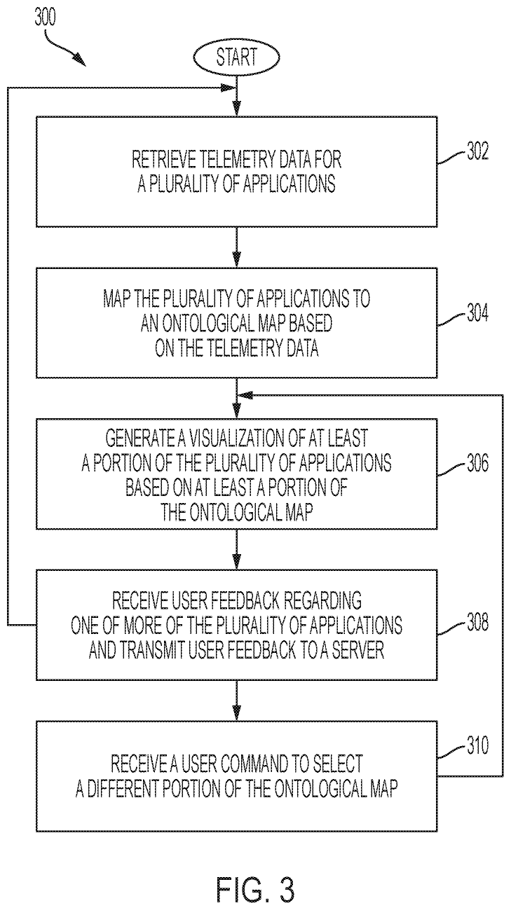

A flow chart of operations performed in the system of 200 on an information handling system is shown in FIG. 3. FIG. 3 is a flow chart illustrating a method of generating an ontological-based visualization of computer programs according to some embodiments of the disclosure. A method 300 begins at block 302 with retrieving telemetry data for a plurality of applications. At block 304, the applications are mapped to an ontological map based on the telemetry data. At block 306, a visualization of at least a portion of the applications is generated based on at least a portion of the ontological map. The user may interact with the visualization of block 306 to identify an application of interest. For example, a user may provide information regarding the type of application that a user desires to identify, such as a type of game, whether role playing, strategy, or simulation.

The user feedback is received at block 308, and that user feedback may provide information regarding the displayed portion of applications. Some of that user feedback may be useful for generating new telemetry data. For example, some user feedback may be ratings or reviews of an application. New telemetry data may be generated based on that user's review of that application relative to the user's review of other applications. That new telemetry data may be transmitted to a server and used as input during other user's ontological visualization of applications. For example, one user's identification of a certain application as an addicting game with respect to other games the user likes may be used to correlate that game with the other games and used as a recommendation for other users. After the user feedback is received, the method 300 may return to block 302 to update the telemetry data at block 302, generate a new ontological map at block 304, and generate a new visualization at block 306. The user feedback regarding the application at block 308 may be an optional element.

After generating the visualization of some applications at block 306, user commands to navigate through the ontological map may be received at block 310. For example, in a universe-based ontological map, a user may issue a command to move from one solar system to another solar system. In response, the method 300 proceeds from block 310 to block 306 to generate a new visualization of a different portion of the applications based on the ontological map, wherein the different portion of applications corresponds to a switch in interest corresponding to the user's command.

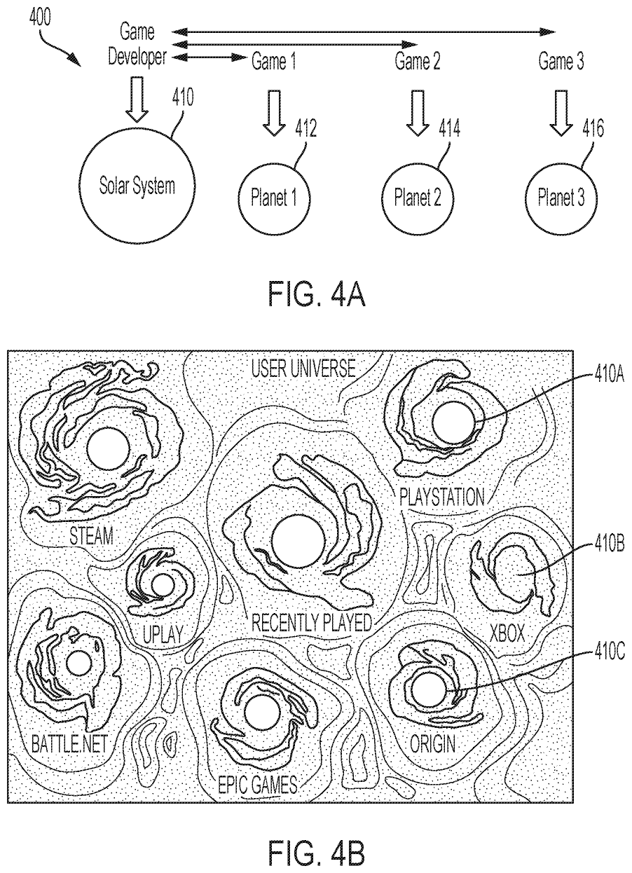

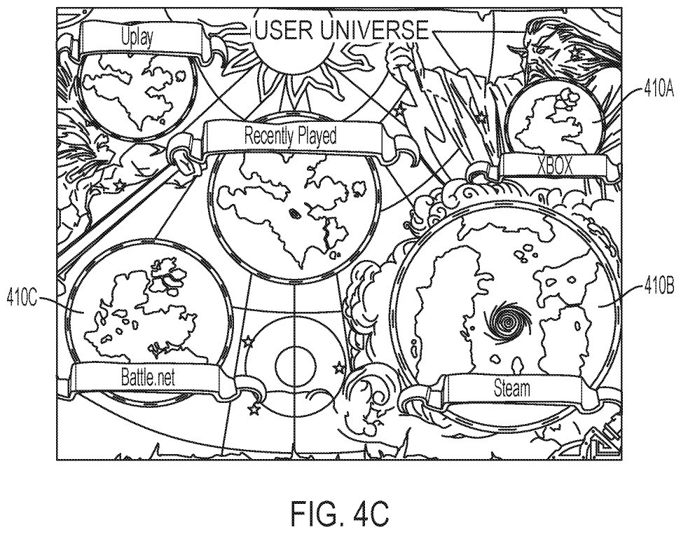

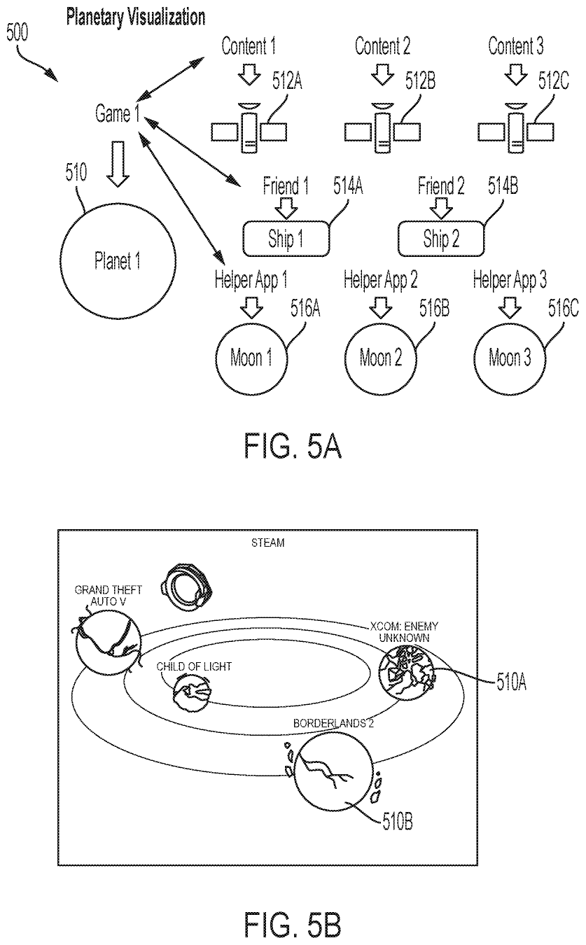

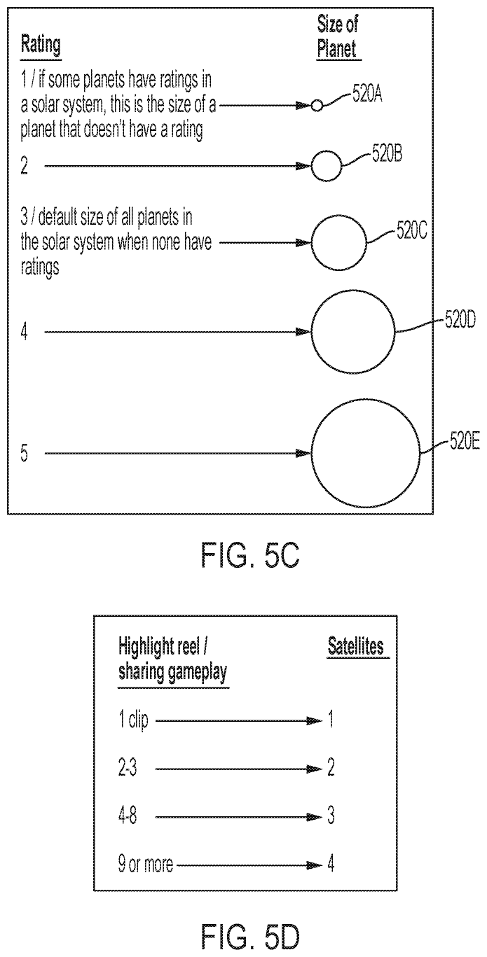

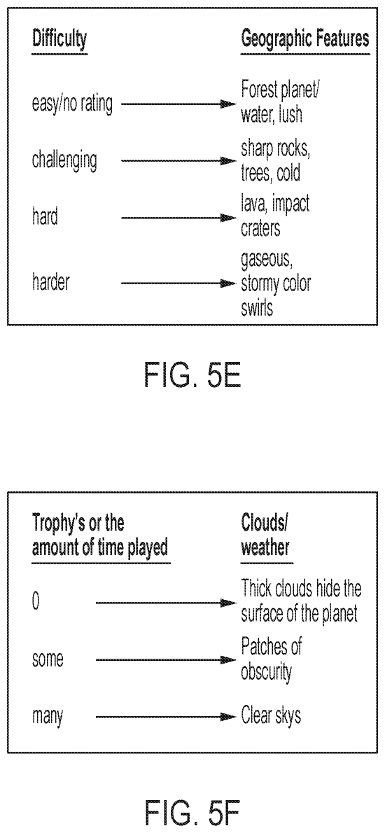

As described above, one ontological mapping for applications is a universe-based mapping. One example of a universe-based ontological mapping is described with reference to FIG. 4A, FIG. 4B, FIG. 5A, FIG. 5B, FIG. 5C, FIG. 5D, FIG. 5E, and FIG. 5F. However, other universe-based ontological mappings, and other ontological mappings of other kinds, may be used for organizing and visualizing a set of applications. One such example is the world-based ontological mapping shown illustrated in FIG. 4C. The universe-based ontological mapping is described below in more detail to illustrate one example operation of the system of FIG. 2 and the method of FIG. 3.

FIG. 4A is a graphical depiction illustrating a solar-system visualization of computer programs according to some embodiments of the disclosure. A solar system 410 may correspond to a game developer and planets 412, 414, and 416 in the solar system 410 may correspond to games released by that game developer. In another similar example, the solar system 410 may correspond to a gaming platform and planets 412, 414, and 416 in the solar system 410 may correspond to games available for purchase through that gaming platform. Some game developers may have their own gaming platform resulting in the solar systems 410 correlating to both a game developer and a gaming platform. FIG. 4B is a screen shot illustrating an example mapping of computer programs into a solar-system visualization according to some embodiments of the disclosure. In the screen shot of FIG. 4B, example solar systems 410 include a PLAYSTATION solar system 410A, a XBOX solar system 410B, and an ORIGIN solar system 410C. FIG. 4C is a screen shot illustrating an example mapping of computer programs into a world visualization according to some embodiments of the disclosure. In another ontological mapping shown in FIG. 4C, different continents on a world may correspond to an XBOX continent 410A, a STEAM continent 410B, and a BATTLE.NET continent 410C. The organization of applications into the ontological map may be based on telemetry data regarding the user's interaction with the applications and/or other user's interaction with the applications.

Telemetry data may be used to generate details within the ontological mapping. Continuing the universe-based ontology example of FIG. 4A and FIG. 4B, details for individual planets may be generated based on telemetry data for the individual application represented by each planet. FIG. 5A is a graphical depiction illustrating a planet visualization for related computer games according to some embodiments of the disclosure. In the representation 500, a planet 510 may correspond to one computer game. Details of the planet 510 may correspond to content available for the game, friends also playing the game, and helper applications available for the game. Content may be visualized as satellites 512A, 512B, and 512C orbiting the planet 510. Friends that have previously or are currently playing the game may be visualized as ships 514A and 514B orbiting planet 510. Helper application may be visualized as moons 516A, 516B, and 516C orbiting the planet 510. An example of planets corresponding to individual applications within a solar system of related applications is shown in FIG. 5B. FIG. 5B is a screen shot illustrating an example mapping of computer programs into a planet visualization according to some embodiments of the disclosure. Planets 510A and 510B correspond to difference applications, such as XCOM and BORDERLANDS, within a universe corresponding to the STEAM gaming platform.

Additional details of the planets in the solar system may be generated based on telemetry data regarding the applications. FIG. 5C is a graphical depiction of details for a planet visualization according to some embodiments of the disclosure. Planets may vary in size from a small planet 520A to larger planets 520B, 520C, 520D, and 520E based on a rating for the corresponding application. If no ratings are available for any applications in the solar system then all may have a default size, such as planet 520C. If some have applications have ratings, applications that do not have rating may have a different default size, such as planet 520A.

FIG. 5D is a graphical depiction of additional details for a planet visualization according to some embodiments of the disclosure. A number of satellites 512A, 512B, and 512C around a planet 510 may vary based on a number of highlight clips generated from the application and/or a number of shared video clips from the application. The number of satellites may be set based on a ratio of satellites to the number of video clips or have a formula or arbitrary scale. In the example of FIG. 5D, one satellite is generated for one clip, two satellites are generated for 2-3 clips, three satellites is generated for 4-8 clips, and 4 satellites is generated for 9 or more clips.

FIG. 5E is a graphical depiction of further details for a planet visualization according to some embodiments of the disclosure. A type of planet 510 may vary based on a difficulty or other characteristic of the application corresponding to the planet 510. For example, games with an easy rating or no difficult rating may be mapped to planets with a lush inhabitable planet with forests and water. A game with a challenging difficult rating may be mapped to planets with sharp rocks, trees, and a cold environment. A game with a hard difficulty rating may be mapped to a planet with lava and impact craters. A game with a harder difficulty rating may be mapped to a planet with gaseous, stormy colors and swirls.

FIG. 5F is a graphical depiction of additional details for a planet visualization according to some embodiments of the disclosure. An aspect of how the planet 510 is displayed within a solar system may vary based on an aspect of a user's interaction with the corresponding application. For example, a number of trophies or badges earned or amount of time spent playing the game may determine how obscured or visible the planet is in the solar system visualization. An example determination of visibility is that little or no play time (such as less than 15 minutes of gameplay or no earned badges) may cause a planet to have thick clouds that hide the surface of the planet, some play time (such as less than 2 hours of gameplay or less than 33% of available badges earned) may cause a planet to have patches of obscurity on the surface of the planet, and that much play time (such as greater than 2 hours of gameplay or more than 33% of available badges earned) may cause a planet to have clear skies.

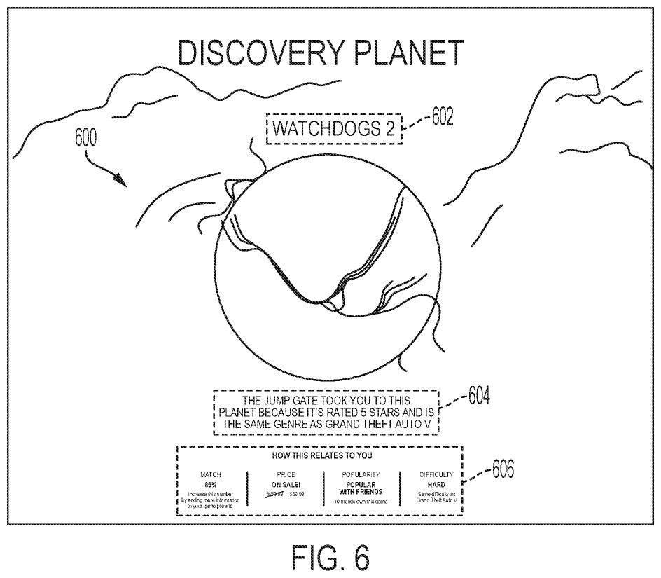

The ontological mapping may be used to identify related content or applications for a user based on telemetry data. FIG. 6 is a screen shot illustrating an example planet visualization for a recommended computer game according to some embodiments of the disclosure. A recommendation 600 may include an application 602 and an explanation 604 that the planet for the application 602 is recommended because the application is also rated five stars and is the same genre as a user's recently-played game. Additional aspects 604 of the recommendation may include a match likelihood to the user as a percentage score, a price of the application through the relevant gaming platform or game developer, a popularity of the game indicating, for example, popularity of the game with the user's friends or users with similar profiles, and a difficulty of the game.

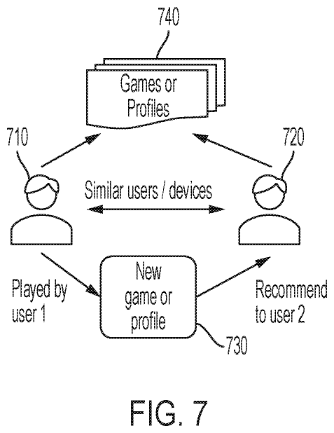

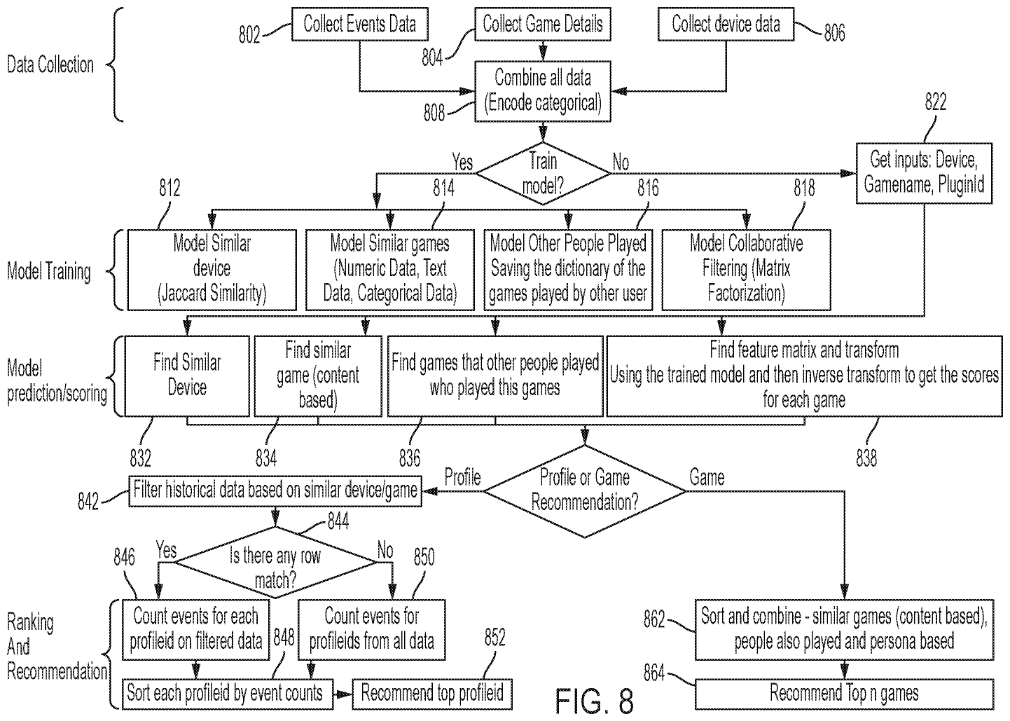

Additional details regarding some embodiments for generating a recommendation are described with reference to FIG. 7 and FIG. 8. FIG. 7 is a block diagram illustrating a recommendation system according to some embodiments of the disclosure. A user 710 and a user 720 may be identified as similar users based on dataset 740, which may include telemetry data useful for identifying similarity of hardware and software configurations and/or similarity of games owned and played. Similar users may be identified by numerical features, such as playing frequency and number of games played by computing a nearest Euclidian distance. Similar users may also or alternatively be identified by categorical features, such as location, types of games played, and/or age range, by using a Jaccard Similarity method. A combined score from the numerical features and the categorical features may be generated by a simple average or weighted average of the two and/or by setting a threshold for the Jaccard similarity. The combined scores may be sorted to generate a list of gamers with highest similarity to a target profile. That highest-ranked user's profile may be used identified and games from that user's profile recommended to the user with the target profile. Based on similarity between the user 710 and the user 720, a new game or user profile 730 may be recommended to the user 720. The recommended game may be made available for purchase. The recommended profile may be used to identify additional games of interest to the user 720 by matching games from the recommended profile to the user 720.

Similar games may be selected based on numerical features, such as ratings and popularity, using a Nearest Euclidian Distance method. Similar games may also or alternatively be selected based on categorical features, such as theme and genre, using a Jaccard similarity method. Similar games may also or alternatively be selected from game descriptions using TF-IDF vectors and/or cosine similarity methods, with the game descriptions obtained from a gaming database. The game descriptions may include game features, such as game modes (e.g., competitive, cooperative), average game length (e.g., minutes or hours), game type (e.g., real-time or turn-based). A Euclidean distance is a distance between two sets of features based on their distance in cartesian co-ordinate system. For example, for features F1 and F2, if game1 has feature values x11, x21 and game2 has feature values x12, x22, then, the distance between game1 and game2 is, √((x12−x11)²+(x22−x21)²). This method produces small distance if the feature values are very close to each other (equally popular rating between two games) and easily scalable to higher dimensional feature sets. A Jaccard similarity is a similarity score calculated based on the number of feature values matched between two games. A higher score reflects a higher number of features matched. Categorical features may not have true numeric values, and the Jaccard similarity method produces numeric similarity scores for these features to allow ranking. A TF-IDF vector is a comparison of text data (e.g., game descriptions) between two games to determine a closeness of the stories played out in the games. The TF-IDF vector comparison method allows for common words between two games to be identified that are not common in other games.

FIG. 8 is a block diagram illustrating a method for recommending games or profiles according to some embodiments of the disclosure. The method begins with collecting events data at block 802, collecting game details at block 804, and collecting device data at block 806, portions or all of which may be combined at block 808. The data may be used to train a recommendation model, such as a machine learning model, or to generate a recommendation. The training may be performed on-demand, at defined intervals, or in a continuous manner. When the training is active, the training may include generating a model for relating similar devices using a Jaccard similarity method at block 812, generating a model for relating similar games (using numeric data, text data, and/or categorical data) at block 814, generating a model of games people play based on a dictionary of games played by users at block 816, and/or performing model collaborative filtering by matrix factorization on the model at block 818.

If the model is trained then recommendations can be generated beginning at block 822 by receiving inputs for finding a recommendation. The inputs may include a device, a game name, a profile identifier and/or a plug-in identifier. Plugin_id is the identifier for plugins. A gamer may have many plugins installed with the game, and those IDs used for finding recommendations. Example plug-ins can include light, sound, power, and/or thermal controls. The profile-id is an identifier for a specific set of settings for the given plugin-id, e.g., for plugin-id ‘thermal’ the profile-id can be ‘high performance’, ‘balanced’ or ‘custom’ values for knobs in thermal plugin. The trained model may be used to generate scores for similarity between users and other users and between games and other games. For example, similar devices to an input device may be identified at block 832, similar games to an input game based on game content may be identified at block 834, similar games may be identified based on games other people played who played the input game at block 836, and/or similar games may be identified by inverse transforming a feature matrix to obtain scores for individual games at block 838.

As described with reference to recommendation 730, either a game or profile can be recommended for a user. If a game recommendation is requested then the method continues to block 862 to combine similar game recommendations based on content and other user's player data and sort the list to recommend, at block 864, one or more games. If a profile recommendation is requested then the method continues to block 842 to filter historical data based on similar devices and similar games and determine if there is a match at block 844. If there is a match then events are counted for each user profile 846 from the filtered data and the profiles sorted by event counts at block 848, such that a recommendation can be produced at block 852. If there is no row match in the historical data, events are counted for profiles across all data at block 850, sorted at block 848, and a recommendation produced at block 852.

The data may include rows listing game, plugin-id, and profile-id. Event rows correspond to similar users/games for A given plugin. In some cases, there may be similar users but none of them played similar games, then, in which case the number of rows matched would be zero. If there are events associated with similar users, games, and/or plugins, then, the several profileids are sorted by the count of events for each profileid. In one example, process given the user (device), gamename and plugin-id, a list of similar users and games are generated. Event data including a list of users-games-plugin-profileid across all users-games-plugin combinations is filtered to retain similar user and similar games for a given pluginid. If there is no row-match (e.g., there is no event data after applying the filters), then the most popular profileid across all the events is recommended at block 852. If there are the rows (e.g., there is event data after applying the filters), then the profile-ids are counted on this subset only to make a recommendation at block 852.

Recommendations for games for a user are enhanced based on the collection of data from different user's game libraries. The recommendations can take into consideration user's device configurations, such that special hardware used for certain games, such as joysticks, steering wheels, and high-end graphics cards, can be used for identifying additional games that benefit from the special hardware. The recommendations are also enhanced by identifying games played by other users with similar profiles based on, for example, the user's games that are owned across multiple game platforms and/or the amount of time each owned game is played and how recently the game has been played.

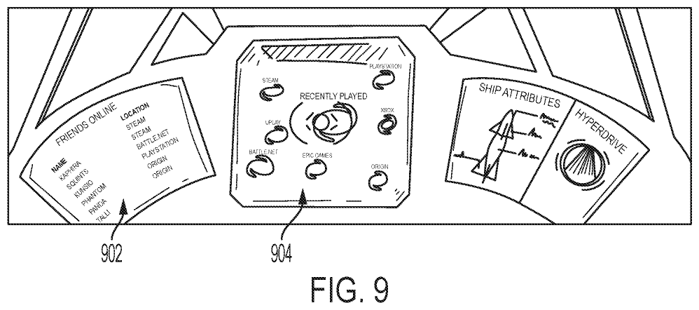

Visualizations other than that shown in figures described above may be used to provide a graphical user interface for the user. Different visualizations of the ontological mapping may allow for different user interaction with the ontological mapping. For example, a virtual reality (VR) or augmented reality (AR) interface may allow a user to interact with the universe-based ontological mapping described in examples provided above. FIG. 9 is a screen shot illustrating a virtual reality visualization for a solar-system visualization according to some embodiments of the disclosure. The universe 904 may be explored through a vessel, and other data from the universe, such as user list 902, incorporated into the interface.

The schematic flow chart diagrams of FIG. 3 and FIG. 8 are generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The operations described above as performed by a processor may be performed by any circuit configured to perform the described operations. Such a circuit may be an integrated circuit (IC) constructed on a semiconductor substrate and include logic circuitry, such as transistors configured as logic gates, and memory circuitry, such as transistors and capacitors configured as dynamic random access memory (DRAM), electronically programmable read-only memory (EPROM), or other memory devices. The logic circuitry may be configured through hard-wire connections or through programming by instructions contained in firmware. Further, the logic circuity may be configured as a general-purpose processor capable of executing instructions contained in software and/or firmware. If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although processors are described throughout the detailed description, aspects of the invention may be implemented on different kinds of processors, such as graphics processing units (GPUs), central processing units (CPUs), and digital signal processors (DSPs). As another example, although processing of certain kinds of data may be described in example embodiments, other kinds or types of data may be processed through the methods and devices described above. As a further example, although computer games are described in embodiments of this disclosure, aspects of the embodiments may be applied to libraries of other applications as well. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
retrieving, by an information handling system, telemetry data for a plurality of applications;
mapping, by the information handling system, the plurality of applications to an ontological map based, at least in part, on the telemetry data; and
generating, by the information handling system, a visualization of at least a portion of the plurality of applications based on at least a portion of the ontological map.

2. The method of claim 1, further comprising generating a recommendation of one or more additional applications based on the telemetry data.

3. The method of claim 2, wherein the step of generating the recommendation is based, at least in part, on similarity of a hardware configuration of the information handling system.

4. The method of claim 2, wherein the step of generating the recommendation is based, at least in part, on a similarity of the one or more additional applications determined by Jaccard similarity with respect to the plurality of applications.

5. The method of claim 1, further comprising generating a recommendation of a user profile based on the telemetry data.

6. The method of claim 1, wherein mapping the plurality of applications comprises mapping based on at least one of a genre, platform, rating, difficulty, amount of time played, trophies earned, and popularity.

7. The method of claim 1, further comprising receiving user feedback regarding one or more of the plurality of applications; and transmitting the user feedback to a server, wherein the retrieved telemetry data is received from the server and incorporates the user feedback correlating applications based on similarity of user feedback received regarding the application.

8. The method of claim 1, further comprising receiving a user command to select a different portion of the ontological map; and generating a second visualization of at least a second portion of the plurality of applications corresponding to the different portion of the ontological map.

9. The method of claim 1, wherein generating the visualization comprises generating a virtual reality (VR) display.

10. An information handling system, comprising:
a processor; and
a memory coupled to the processor, wherein the processor is configured to perform steps comprising:
retrieving, by an information handling system, telemetry data for a plurality of applications;
mapping, by the information handling system, the plurality of applications to an ontological map based, at least in part, on the telemetry data; and
generating, by the information handling system, a visualization of at least a portion of the plurality of applications based on at least a portion of the ontological map.

11. The information handling system of claim 10, wherein the processor is further configured to perform steps comprising generating a recommendation of one or more additional applications based on the telemetry data.

12. The information handling system of claim 11, wherein the step of generating the recommendation is based, at least in part, on price, popularity with friends, rating, genre, and difficulty.

13. The information handling system of claim 10, wherein mapping the plurality of applications comprises mapping based on at least one of a genre, platform, rating, difficulty, amount of time played, trophies earned, and popularity.

14. The information handling system of claim 10, wherein the processor is further configured to perform steps comprising: receiving user feedback regarding one or more of the plurality of applications; and transmitting the user feedback to a server, wherein the retrieved telemetry data is received from the server and incorporates the user feedback correlating applications based on similarity of user feedback received regarding the application.

15. The information handling system of claim 10, wherein the processor is further configured to perform steps comprising: receiving a user command to select a different portion of the ontological map; and generating a second visualization of at least a second portion of the plurality of applications corresponding to the different portion of the ontological map.

16. A computer program product, comprising:
a non-transitory computer readable medium comprising code to perform steps comprising:
retrieving, by an information handling system, telemetry data for a plurality of applications;
mapping, by the information handling system, the plurality of applications to an ontological map based, at least in part, on the telemetry data; and
generating, by the information handling system, a visualization of at least a portion of the plurality of applications based on at least a portion of the ontological map.

17. The computer program product of claim 15, wherein the medium further comprises code to perform steps comprising generating a recommendation of one or more additional applications based on the telemetry data, wherein the recommendation is based, at least in part, on price, popularity with friends, rating, genre, and difficulty.

18. The computer program product of claim 15, wherein the medium further comprises code to perform steps comprising: receiving user feedback regarding one or more of the plurality of applications; and transmitting the user feedback to a server, wherein the retrieved telemetry data is received from the server and incorporates the user feedback correlating applications based on similarity of user feedback received regarding the application.

19. The computer program product of claim 15, wherein the medium further comprises code to perform steps comprising: receiving a user command to select a different portion of the ontological map; and generating a second visualization of at least a second portion of the plurality of applications corresponding to the different portion of the ontological map.

20. The computer program product of claim 15, wherein mapping to the ontological map comprises mapping the plurality of applications to a universe map.
